(19) United States
(12) Patent Application Publication
(10) Pub. No.: US 2026/0128505 A1
(43) Pub. Date: May 7, 2026

(54) MOUNTING ASSEMBLY FOR MOBILE RADIO

(71) Applicant: MOTOROLA SOLUTIONS, INC., Chicago, IL (US)

(72) Inventors: Chor Cheow Ng, Butterworth (MY); Chee Kit Chan, Bayan Lepas (MY); Wey Chien Heng, Air Itam (MY); Chee Hean Loke, Georgetown (MY); Toy Muan Yoong, Bayan Baru (MY)

(21) Appl. No.: 18/937,641

(22) Filed: Nov. 5, 2024

(51) Int. Cl. H01Q 1/32; H01Q 3/02

(52) U.S. Cl. CPC H01Q 1/32; H01Q 3/02

(57) ABSTRACT

A trunnion bracket including a base configured to be mounted to a surface of the vehicle and a pair of upright support arms configured to receive an electronic transceiver. The upright support arms each include an outer face, an inner face, and an aperture defining a pivot axis. The trunnion bracket includes a plurality of tabs disposed on the inner face. The plurality of tabs include a pair of guide tabs that guide threaded holes of the transceiver to align with the apertures of the upright support arms and a stop tab that abuts a portion of the transceiver to inhibit the transceiver from moving further toward the base once the threaded holes of the transceiver align with the apertures of the upright support arm.

### BACKGROUND

Mobile transceivers, such as mobile radio units, and the like, are often used in vehicles. Preferably, the transceiver is mounted within the vehicle—usually under a passenger seat, under the vehicle dashboard, or on top of the dashboard. A bracket is commonly coupled to the desirable location in the vehicle and holds the transceiver.

### SUMMARY

The present disclosure provides, in one aspect, a trunnion bracket for supporting an electronic transceiver within a vehicle, the trunnion bracket including: a base configured to be mounted to a surface of the vehicle; a pair of upright support arms configured to receive and mount the transceiver relative to the surface of the vehicle, the pair of upright support arms each including: an outer face that faces away from the transceiver when the transceiver is received within the trunnion bracket, an inner face that faces toward the transceiver when the transceiver is received within the trunnion bracket, and an aperture defining a pivot axis; and a plurality of tabs disposed on the inner face of each upright support arm, the plurality of tabs on one of the inner faces extending toward the plurality of tabs on the other of the inner faces along a direction parallel to the pivot axis, the plurality of tabs including: a pair of guide tabs that guide threaded holes of the transceiver to align with the apertures of the upright support arms, and a stop tab that abuts a portion of the transceiver to inhibit the transceiver from moving further toward the base once the threaded holes of the transceiver align with the apertures of the upright support arm.

The present disclosure provides, in another aspect, a trunnion bracket for supporting an electronic transceiver within a vehicle, the trunnion bracket including: a base configured to be mounted to a surface of the vehicle; a pair of upright support arms configured to receive and mount the transceiver relative to the surface of the vehicle, the pair of upright support arms each including: an outer face that faces away from the transceiver when the transceiver is received within the trunnion bracket, an inner face that faces toward the transceiver when the transceiver is received within the trunnion bracket, and an aperture defining a pivot axis; at least one tab extending away from the inner face of each upright support arm along a direction parallel to the pivot axis, the at least one tab guides the transceiver into the trunnion bracket to coaxially align threaded holes of the transceiver with the apertures of the upright support arms; and a nest coupled to the outer face of each upright support arm that are configured to funnel a fastener into the apertures of the upright support arms.

The present invention provides, in another aspect, a mounting assembly configured to be mounted to a surface of a vehicle, the mounting assembly including: a transceiver including threaded holes on opposing sides of the transceiver and an annular ring disposed around the threaded holes extending away from the transceiver; a trunnion bracket for receiving and mounting the transceiver, the trunnion bracket including at least one tab extending away from the trunnion bracket and engages the annular ring of the transceiver to guide the transceiver into the trunnion bracket until the threaded holes of the transceiver coaxially align with apertures of the trunnion bracket, at which point the at least one tab limits the threaded holes of the transceiver from moving beyond the apertures of the trunnion bracket; and a nest coupled to the trunnion bracket that are configured to funnel a fastener into the apertures of the trunnion, the nest including a rib that extends radially inward from an aperture of the nest, which provides tactile feedback to a user as threads of the fastener slide past the rib, wherein the trunnion bracket is disposed between the transceiver and the nest.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments, examples, aspects, and features that include the claimed subject matter, and explain various principles and advantages.

FIG. 1 is a perspective view of a mount assembly in accordance with one example, illustrating a mobile radio transceiver being mounted under a passenger seat for a vehicle via a trunnion bracket.

FIG. 2A is a perspective view of the trunnion bracket of FIG. 1, illustrating a pair of upright support arms extending upward from a base.

FIG. 2B is a plan view of an inner face of one of the upright support arms, illustrating a lead-in angle.

FIG. 3 is a perspective view of an outer face of one of the upright support arms, illustrating a nest and a fastener exploded away from the upright support arm.

FIG. 4 is a cross-sectional view of the mounting assembly of FIG. 1, illustrating the fastener locating an aperture of the nest.

FIG. 5 is a cross-sectional view of the mounting assembly of FIG. 1, illustrating the fastener being located within the aperture of the nest.

FIG. 6 is a cross-sectional view of the mounting assembly of FIG. 1, illustrating the fastener threadably engaging a threaded hole of the transceiver.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments, examples, aspects, and features.

The apparatus and method components have been represented where appropriate by conventional symbols in the drawings, showing only those specific details that are pertinent to understanding the embodiments, examples, aspects, and features described and illustrated so as not to obscure the disclosure with details that will be readily apparent to those of ordinary skill in the art having the benefit of the description herein.

### DETAILED DESCRIPTION

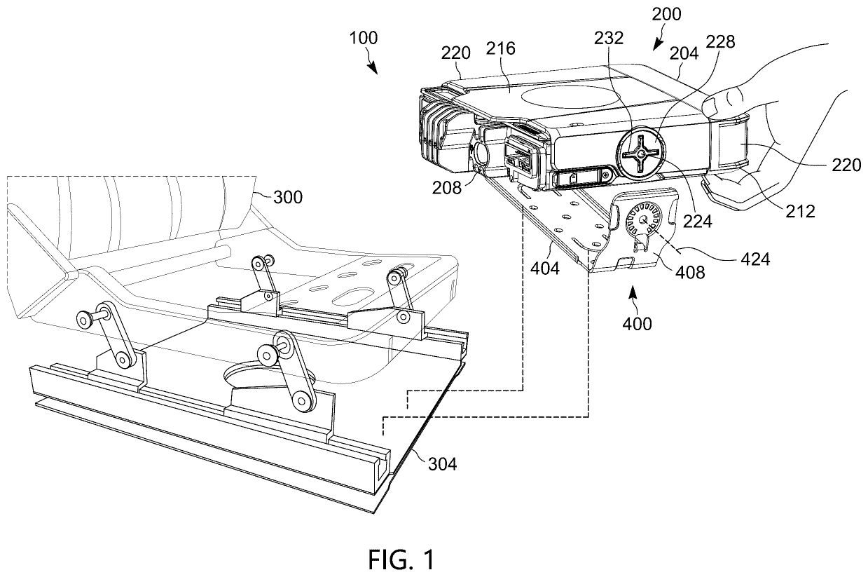

FIG. 1 illustrates an example of a mounting assembly 100 including a mobile radio or electronic transceiver unit 200 (herein after transceiver) that is mounted within a vehicle (not shown). In the example shown, the mounting assembly 100 is mounted underneath a passenger seat 300, and in this particular example, to a surface 304 of a vehicle that is underneath the passenger seat 300. The mounting assembly 100 further includes a trunnion bracket 400 for mounting the transceiver 200 relative to the surface 304 of the vehicle.

With continued reference to FIG. 1, the transceiver 200 includes a front face 204, a rear face 208, a bottom face 212, a top face 216, and opposing side faces 220. The front face 204 may include various controls for a user to manipulate to control the transceiver 200. Thus, the front face 204 is preferably accessible to a user within the vehicle. The opposing side faces 220 are configured to interface with the trunnion bracket 400 when the transceiver 200 is received by the trunnion bracket 400. In one instance, each opposing side face 220 of the transceiver 200 includes a threaded hole 224 and an annular ring 228 disposed around the threaded hole 224. The annular ring 228 on each side face 220 extends away from the respective side face 220.

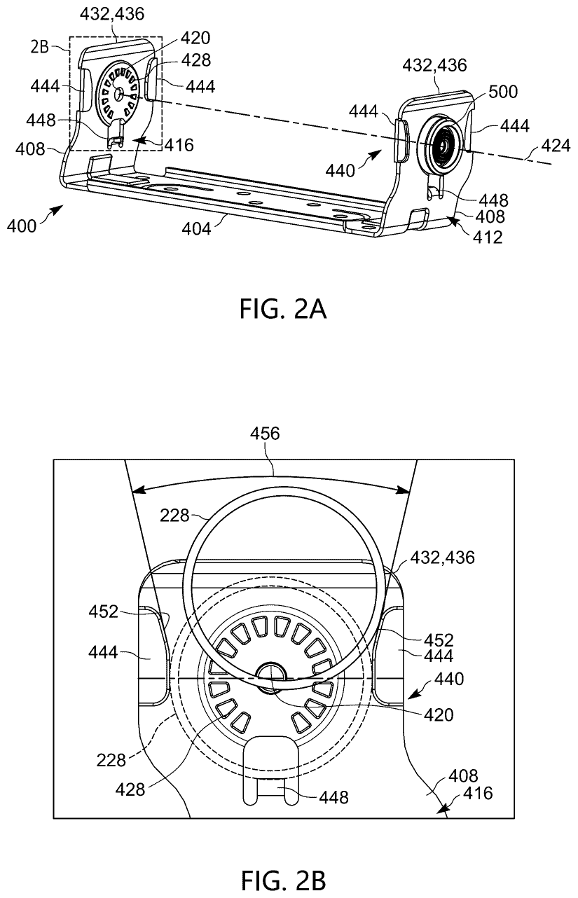

With reference to FIG. 2A, the trunnion bracket 400 includes a base 404 that is configured to be mounted to the surface 304 of the vehicle and a pair of upright support arms 408 that extend from the base 404. In one instance, the upright support arms 408 are bent relative to the base 404 to be substantially perpendicular to the base 404. That is, the upright support arms 408 are integrally formed with the base 404. In other words, the trunnion bracket 400 is a monolithic component, while in other examples, the upright support arms 408 may be separate from the base 404. The upright support arms 408 are configured to receive and mount the transceiver 200 relative to the surface 304 of the vehicle. Each upright support arm 408 includes an outer face 412 that faces away from the transceiver 200 when the transceiver 200 is received within the trunnion bracket 400. Furthermore, each upright support arm 408 includes an inner face 416 that faces toward the transceiver 200 when the transceiver 200 is received within the trunnion bracket 400. There is an aperture 420 that extends through each upright support arm 408 and define a pivot axis 424.

When the transceiver 200 is received by the trunnion bracket 400, the transceiver may pivot about the pivot axis 424 to a desired angular position. As best illustrated in FIG. 2B, a detent mechanism 428 is configured to rotationally lock the transceiver 200 in a plurality of present angles about the pivot axis 424. For example, the detent mechanism 428 of the illustrated example enables the transceiver 200 to pivot about the pivot axis 424 in 22.5-degree increments. Commonly, the bottom face 212 of the transceiver 200 is parallel to the base 404 of the trunnion bracket 400 when the transceiver 200 is mounted to the trunnion bracket 400 but may alternatively be in different orientations. The detent mechanism 428 of the illustrated example is disposed radially around the aperture 420 and disposed on the inner face 416 of each support arm 408. In other examples, there may only be a single detent mechanism 428 on one of the support arms 408. The detent mechanism 428 is configured to interface with a corresponding protrusion 232 of the transceiver 200 to align the transceiver 200 to various preset angles.

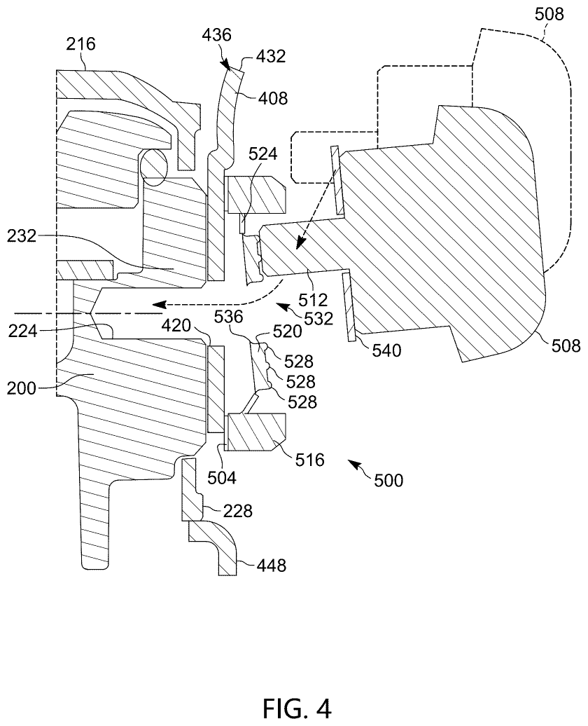

With reference to FIGS. 2A and 2B, the trunnion bracket 400 further includes a lip 432 disposed at a distal end 436 of each support arm 408 and a plurality of tabs 440 disposed on the inner face 416 of each support arm 408. The lip 432 bends or flares outward, such that the distal end 436 extends outward beyond the outer face 412 (as best illustrated in FIG. 4). The plurality of tabs 440 facilitate guiding the transceiver 200 into proper alignment within the trunnion bracket 400, as explained in further detail below.

The plurality of tabs 440 extend away from the respective inner face 416 along a direction parallel to the pivot axis 424. That is, the plurality of tabs 440 on one of the support arms 408 extend toward the plurality of tabs 440 on the other one of the support arms 408. The overall width of the transceiver 200 (measured from the annular ring 228 on one side face 220 to the annular ring 228 on the other side face 220) is substantially the same as the distance between inner faces 416 of the trunnion bracket 400. Since the plurality of tabs 440 extend inward from the inner faces 416, the annular rings 228 interact with and slide along the plurality of tabs 440 to seat the annular rings 228 within the plurality of tabs 440. That is, the plurality of tabs 440 mechanically interfere with the annular rings 228 to guide the transceiver 200 into the trunnion bracket 400. Since the plurality of tabs 440 on each inner face 416 are identical, only one of the plurality of tabs 440 will be described for sake or brevity.

The plurality of tabs 440 include a pair of guide tabs 444 disposed on opposite sides of the aperture 420 and a stop tab 448 disposed on an opposite side of the aperture 420 relative to the distal end 436. The annular ring 228 interacts with the pair of guide tabs 444 before the stop tab 448 during the assembly process. The pair of guide tabs 444 funnel the annular ring 228 into the trunnion bracket 400 in a fore-and-aft (i.e., horizontal) direction, whereas the stop tab 448 limits the amount the annular ring 228 is inserted into the trunnion bracket 400 (i.e., along a vertical direction from a frame of reference of FIG. 2A). Stated another way, each pair of guide tabs 444 guide the threaded holes 224 of the transceiver 200 to align with the apertures 420 of the support arms 408, while each stop tab 448 abuts a portion of the annular ring 228 to inhibit the transceiver 200 from moving further toward the base 404 once the threaded holes 224 align with the apertures 420 of the support arms 408.

With continued reference to FIGS. 2A and 2B, the pair of guide tabs 444 include slide surfaces 452 that the annular rings 228 slide against while being inserted into the trunnion bracket 400. The slide surfaces 452 collectively define a lead-in angle 456 of approximately 20-degrees to approximately 40-degrees. In one instance, the lead-in angle 456 of the illustrated example is approximately 30-degrees. In other examples, the lead-in angle 456 may be fewer than 20-degrees or greater than 40-degrees. The lead-in angle 456 defined by the slide surfaces 452 facilitate in funneling the transceiver 200 into the trunnion bracket 400. If, for example, the annular ring 228 abuts one of guide tabs 444, the annular ring 228 slides against the slide surface 452 of that particular guide tab 444 and funneled to ensure the threaded holes 224 align with the apertures 420. The features of the support arm 408 (e.g., the flared lip 432 and the plurality of tabs 440) allow the transceiver 200 to be placed within the trunnion bracket 400 using one hand.

The plurality of tabs 440 and the detent mechanism 428 are integrally formed with the support arm 408. The pair of guide tabs 444 and the detent mechanisms 428, for example, are stamped (via a press or other similar means) to create the features. Similarly, the stop tabs 448 are formed by a combination of stamping and bending to create the feature. Although the illustrated example illustrates a plurality of tabs 440, in other examples, the support arms 408 may alternatively only define a single arcuate tab (which may or may not be integral with the trunnion bracket 400) that funnels, catches, and holds the annular ring 228 to align the threaded holes 224 with the apertures 420.

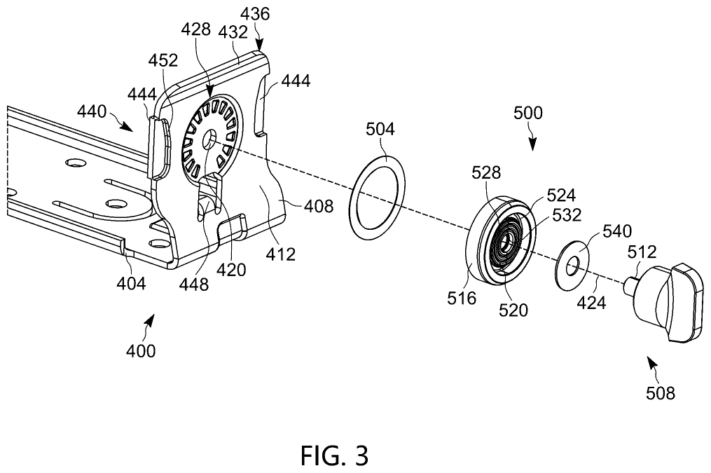

With reference to FIG. 3, the mounting assembly 100 further includes a fastener nest 500. The fastener nest 500 is coupled to the outer face 412 of each support arm 408 via an adhesive tape 504. The fastener nest 500 facilitates blindly inserting a fastener 508 (e.g., thumb screw, etc.) through the aperture 420 of the trunnion bracket 400. That is, the fastener nest 500 facilitates funneling or guiding the fastener 508 into the aperture 420. The fastener 508 includes a threaded shaft 512 that is configured to pass through the nest 500 and threadably engage the threaded holes 224 of the transceiver 200, as described in further detail below.

The fastener nest 500 includes an outer ring 516, an inner ring 520 disposed radially within the outer ring 516, and a web 524 that connects the inner ring 520 to the outer ring 516.

The inner ring 520 is capable of moving relative to the outer ring 516 via the web 524. The nest 500 is a monolithic component and composed of an elastomeric material to allow the nest to elastically deform. Even though the nest 500 is composed of the same material, the outer ring 516 is more rigid than the inner ring 520 due to the outer ring 516 being thicker than the inner ring 520.

With reference to FIG. 4, the inner ring 520 includes a series of annular projections 528 that extend away from the inner ring 520 along a direction parallel to the pivot axis 424.

Each annular projection 528 is radially offset from each other, meaning each annular projection 528 has a different diameter. The series of annular projections 528 are all concentric relative to each other. The series of annular projections 528 provide tactile feedback to a user blindly sliding the fastener 508 along the series of annular projections 528. This is a result of a distal end of the fastener 508 catching each annular projection 528 as it slides past each annular projection 528, which creates an audible noise and physical clicking (i.e., small movement, vibration, etc.) of the fastener 508. This tactile feedback informs a user that the threaded shaft 512 is near an aperture 532 of the nest 500 through which the fastener 508 extends. In the illustrated example, there are three annular projections 528 that are in the form of rings, while in other examples, there may be fewer or greater than three projections 528 in the form of other shapes.

The aperture 532 of the nest 500 coaxially aligns with the aperture 420 of the support arm 408. As such, when the fastener 508 is inserted through the aperture 532 of the nest 500, the fastener 508 may then pass through the aperture 420 of the support arm 408. The aperture 532 of the nest 500 includes a rib 536 that extends radially inward from the aperture 532 toward the pivot axis 424. The rib 536 provides tactile feedback to a user as the threaded shaft 512 of the fastener 508 slide past the rib 536. This is a result of each thread along the threaded shaft 512 catching the rib 536 as they slide past the rib 536, which creates an audible noise and physical clicking of the fastener 508. This tactile feedback informs a user that the threaded shaft 512 is being inserted into the aperture 532 and translating towards the aperture 420 of the support arm 408. The threaded shaft 512 catches the rib 536 because the rib 536 has an inner diameter that is slightly smaller than the outer diameter of the threaded shaft 512.

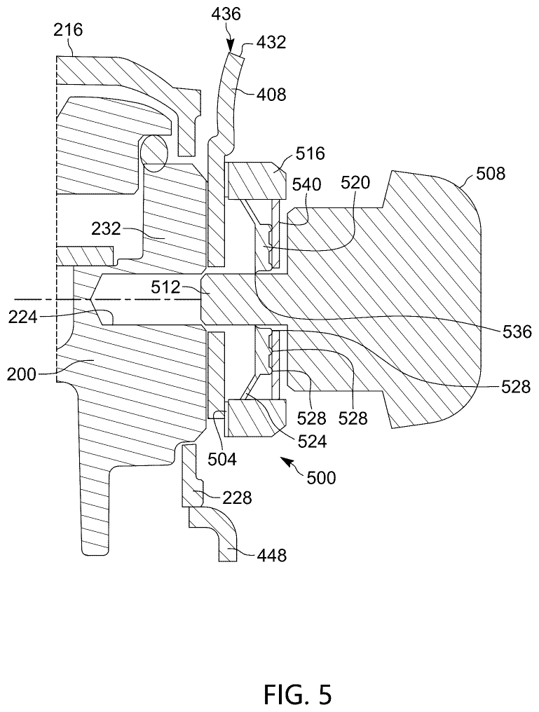

With reference to FIG. 5, the aperture 532 of the nest 500 is capable of supporting the fastener 508 without a user holding the fastener 508. Since the inner diameter of the rib 536 is slightly smaller than the outer diameter of the threaded shaft 512, the rib 536 grips the fastener 508 when the fastener 508 is inserted into the aperture 532, and thus, inhibits the fastener 508 from falling out of the aperture 532 even when a user is no longer holding the fastener 508. As such, the aperture 532 of the nest 500 is configured to support the fastener 508 without the fastener 508 being threadably engaged with the threaded holes 224 of the transceiver 200.

With reference to FIGS. 3-6, a washer 540 is provided around the threaded shaft 512 of the fastener 508, which engages the inner ring 520 of the nest 500 once assembled. That is, the washer 540 is disposed between the fastener 508 and the inner ring 520 of the nest 500. The washer 540 allows the fastener 508 to engage a contact surface area that is larger than the contact surface area of the annular projections 528 on the inner ring 520, which provides lower rotational contact friction between the thumb screw and the flat metal washer and protecting the rubber from being worn.

During assembly of the mounting assembly 100, the base 404 of the trunnion bracket 400 is coupled (via fasteners) to the surface 304 of the vehicle. In particular, in the illustrated example, the trunnion bracket 400 is fastened to the surface 304 of the vehicle under the passenger seat 300 with the support arms 408 extending toward the passenger seat 300, as shown in FIG. 1. With further reference to FIG. 1, a user may grasp the transceiver 200 with one-hand and blindly maneuver the transceiver 200 toward the trunnion bracket 400 under the passenger seat 300. A user positions the transceiver 200 above the trunnion bracket 400 (from a frame of reference of FIG. 1), in which the annular rings 228 of the transceiver 200 are adjacent the distal ends 436 of the support arms 408. At this point, a user may lower the transceiver 200 into the trunnion bracket 400 along a direction perpendicular to the pivot axis 424 until the annular rings 228 are received by the plurality of tabs 440. During this time, the annular rings 228 are funneled (i.e., guided) between the support arms 408 by the lips 432 and the plurality of tabs 440 of the support arms 408. In one instance, the annular rings 228 (solid lines of FIG. 2B) may slide against the lips 432 first to be guided between the support arms 408 and then the lead-in angle 456 enable the annular rings 228 to slide against the guide tabs 444 until the threaded holes 224 are coaxially aligned with the apertures 420. Here, the annular rings 228 (dashed lines of FIG. 2B) abut against the stop tabs 448 to limit the transceiver 200 from moving any further toward the base 404 of the trunnion bracket 400. Not only is the transceiver 200 fully supported by the trunnion bracket 400 at this time, the threaded holes 224 of the transceiver 200 are also coaxially aligned with the apertures 420 of the trunnion bracket 400, making it easy for a user to insert the fastener 508 through both the aperture 420 and the threaded holes 224 succinctly.

At this point, the trunnion bracket 400 is disposed between the transceiver 200 and the nest 500. With the transceiver 200 received by the trunnion bracket 400, the fastener 508 is blindly maneuvered toward the nest 500—which has already been coupled to the outer face 412 of the support arm 408 via the adhesive tape 504. As shown in FIG. 4, a user may blindly locate the aperture 532 of the nest 500 by first locating the outer ring 516 since the outer ring 516 is distinguishable among other components as it sits proud on the outer face 412. At this point, a user maneuvers the distal end of the threaded shaft 512 within the confines of the outer ring 516 to slide the distal end of the threaded shaft 512 across the series of annular projections 528 on the inner ring 520 (FIG. 4). This produces tactile feedback to a user to alert the user that the threaded shaft 512 is near the aperture 532. Once the fastener 508 is inserted into the aperture 532, the threaded shaft 512 slides past the rib 536 of the aperture 532, which produces additional tactile feedback to a user to alert the user that the threaded shaft 512 is being inserted through the aperture 532 of the nest 500. At this point, the threaded shaft 512 is easily guided through the aperture 420 of the support arm 408 toward the threaded hole 224 of the transceiver 200 (FIG. 5) because the aperture 532, the aperture 420, and the threaded hole 224 are all coaxially aligned. Prior to threading the threaded shaft 512 into the threaded hole 224, a user may leave the fastener 508 in the aperture 532 without the fastener 508 disengaging the nest 500 because the rib 536 grips and maintains the fastener 508 in the aperture 532.

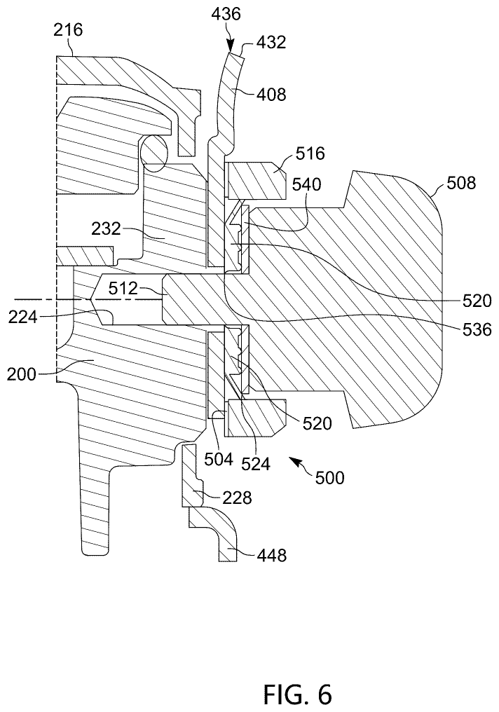

Subsequently, a user rotates the fastener 508 to threadably engage the threaded shaft 512 with the threaded hole 224. While tightening the fastener 508, the washer 540 abuts and exerts a force on the inner ring 520, thereby moving the inner ring 520 toward the outer face 412 of the support arm 408. Not only does the web 524 allow the inner ring 520 to move relative to the outer ring 516, but the web 524 also biases the inner ring 520 towards its default state (as shown in FIG. 5). As such, when the inner ring 520 is moved to a depressed state (as shown in FIG. 6), the inner ring 520 and the web 524 act as a spring washer and exert a biased force against the fastener 508. In other words, the web 524 collapses when the inner ring 520 is moved from the default state to the depressed state. This, in turn, serves to increase the friction between the threaded shaft 512 and the threaded hole 224 to inhibit the fastener 508 from inadvertently unthreading (i.e., loosening) from the threaded hole 224 due to vibration and shock within the vehicle. The elastomeric material (i.e., rubber) of the nest 500 also increases the biasing force against the fastener 508 as the inner ring 520 is sandwiched between the trunnion bracket 400 and the washer 540 (or fastener 508).

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A trunnion bracket for supporting an electronic transceiver within a vehicle, the trunnion bracket comprising:
a base configured to be mounted to a surface of the vehicle;
a pair of upright support arms configured to receive and mount the transceiver relative to the surface of the vehicle, the pair of upright support arms each including:
an outer face that faces away from the transceiver when the transceiver is received within the trunnion bracket,
an inner face that faces toward the transceiver when the transceiver is received within the trunnion bracket, and
an aperture defining a pivot axis; and
a plurality of tabs disposed on the inner face of each upright support arm, the plurality of tabs on one of the inner faces extending toward the plurality of tabs on the other of the inner faces along a direction parallel to the pivot axis, the plurality of tabs including:
a pair of guide tabs that guide threaded holes of the transceiver to align with the apertures of the upright support arms, and
a stop tab that abuts a portion of the transceiver to inhibit the transceiver from moving further toward the base once the threaded holes of the transceiver align with the apertures of the upright support arm.

2. The trunnion bracket of claim 1, further comprising a lip at a distal end of each upright support arm that flares outward.

3. The trunnion bracket of claim 1, wherein the transceiver is configured to be placed within the trunnion bracket using one hand.

4. The trunnion bracket of claim 1, wherein the pair of guide tabs collectively define a lead-in angle of 20-degrees to 40-degrees.

5. The trunnion bracket of claim 1, further comprising a detent mechanism disposed radially around the aperture on the inner face of each upright support arm, the detent mechanism configured to rotationally lock the transceiver in a plurality of present angles about the pivot axis.

6. The trunnion bracket of claim 1, further comprising a nest coupled to the outer face of each upright support arm configured to funnel a fastener into the apertures of the upright support arms.

7. The trunnion bracket of claim 6, wherein the nest includes an outer ring, an inner ring, and a web connecting the outer ring to the inner ring.

8. The trunnion bracket of claim 7, wherein the inner ring is capable of moving relative to the outer ring.

9. The trunnion bracket of claim 7, wherein the inner ring has a series of annular projections that extend away from the inner ring in a direction parallel to the pivot axis, which provide tactile feedback to a user as the fastener slides along the series of annular projections.

10. The trunnion bracket of claim 7, wherein the inner ring includes an aperture and a rib extending radially inward from the aperture toward the pivot axis, which provides tactile feedback to a user as threads of the fastener slide past the rib.

11. The trunnion bracket of claim 10, wherein the aperture of the inner ring is configured to support the fastener without the fastener being threadably engaged with the threaded holes of the transceiver.

12. The trunnion bracket of claim 7, wherein the nest is composed of an elastomeric material.

13. A trunnion bracket for supporting an electronic transceiver within a vehicle, the trunnion bracket comprising:
a base configured to be mounted to a surface of the vehicle;
a pair of upright support arms configured to receive and mount the transceiver relative to the surface of the vehicle, the pair of upright support arms each including:
an outer face that faces away from the transceiver when the transceiver is received within the trunnion bracket,
an inner face that faces toward the transceiver when the transceiver is received within the trunnion bracket, and
an aperture defining a pivot axis;
at least one tab extending away from the inner face of each upright support arm along a direction parallel to the pivot axis, the at least one tab guides the transceiver into the trunnion bracket to coaxially align threaded holes of the transceiver with the apertures of the upright support arms; and
a nest coupled to the outer face of each upright support arm that are configured to funnel a fastener into the apertures of the upright support arms.

14. The trunnion bracket of claim 13, wherein the at least one tab includes a pair of guide tabs that guide the threaded holes of the transceiver to align with the apertures of the upright support arms and a stop tab that abuts a portion of the transceiver to inhibit the transceiver from moving further toward the base once the threaded holes of the transceiver align with the apertures of the upright support arm.

15. The trunnion bracket of claim 14, wherein the pair of guide tabs collectively define a lead-in angle of 20-degrees to 40-degrees.

16. The trunnion bracket of claim 13, wherein the transceiver is configured to be placed within the trunnion bracket using one hand.

17. The trunnion bracket of claim 13, wherein the nest is composed of an elastomeric material and includes an outer ring, an inner ring, and a web connecting the outer ring to the inner ring, wherein the inner ring is capable of moving relative to the outer ring.

18. The trunnion bracket of claim 17, wherein the inner ring has a series of annular projections that extend away from the inner ring along a direction parallel to the pivot axis, which provide tactile feedback to a user as the fastener slides along the series of annular projections, and a rib extending radially inward from an aperture of the inner ring toward the pivot axis, which provides tactile feedback to a user as threads of the fastener slide past the rib.

19. The trunnion bracket of claim 17, further comprising an aperture of the inner ring is configured to support the fastener without the fastener being threadably engaged with the threaded hole of the transceiver.

20. A mounting assembly configured to be mounted to a surface of a vehicle, the mounting assembly comprising:
a transceiver including threaded holes on opposing sides of the transceiver and an annular ring disposed around the threaded holes extending away from the transceiver;
a trunnion bracket for receiving and mounting the transceiver, the trunnion bracket including at least one tab extending away from the trunnion bracket and engages the annular ring of the transceiver to guide the transceiver into the trunnion bracket until the threaded holes of the transceiver coaxially align with apertures of the trunnion bracket, at which point the at least one tab limits the threaded holes of the transceiver from moving beyond the apertures of the trunnion bracket; and
a nest coupled to the trunnion bracket that are configured to funnel a fastener into the apertures of the trunnion, the nest including a rib that extends radially inward from an aperture of the nest, which provides tactile feedback to a user as threads of the fastener slide past the rib,
wherein the trunnion bracket is disposed between the transceiver and the nest.
